(19) United States
(12) Patent Application Publication
(10) Pub. No.: US 2023/0132834 A1
(43) Pub. Date: May 4, 2023

(54) PEOPLE DETECTION

(71) Applicants: UNIVERSITEIT GENT, Gent (BE); IMEC VZW, Leuven (BE)

(72) Inventors: Marwan YUSUF, Gent (BE); Emmeric TANGHE, Gent (BE); Wout JOSEPH, Vichte (BE); Luc MARTENS, De Pinte (BE)

(21) Appl. No.: 17/910,988

(22) PCT Filed: Mar. 11, 2021
(86) PCT No.: PCT/EP2021/056246

§ 371 Date: Sep. 12, 2022

(30) Foreign Application Priority Data
Mar. 13, 2020 (EP) 20163119.9

(51) Int. Cl. G01V 3/12; G01S 13/04

(52) U.S. Cl. CPC G01V 3/12; G01S 13/04

(57) ABSTRACT

Example embodiments describe a method for estimating a number of persons present in a room including i) obtaining measurements of electromagnetic sounding signals transmitted within the room; ii) determining at least one reverberation time from the measurements; iii) determining the number of people in the room based on the at least one reverberation time, on a room parameter indicative for a capacity of the room for absorbing the signals and a person parameter indicative for an average capacity of a person for absorbing the signals.

### TECHNICAL FIELD

Various example embodiments relate, amongst others, to methods for estimating a number of persons present in a room.

### BACKGROUND

Automatic detection of the number of people present in a room has different practical applications ranging from building automation over surveillance to safety monitoring.

Different types of solutions are known today each with their advantages and disadvantages. A first type are the image-based solutions wherein a camera system derives the number of people present based on recorded images. Image-based solutions are however prone to blind spots, need a certain amount of lightning, are sensitive to environmental conditions, pose privacy issues and are computationally intensive due to the image processing which is often based on machine learning algorithms.

Another type is based on capturing the infra-red light emitted by people via passive infra-red, PIR, sensors. However, such solution still suffers from blind spots and environmental conditions. A similar solution is by detection of diffuse light emitted by light-emitting diodes, LEDs but also poses the same problems.

Yet another type of solution is based on radio-frequency, RF, signals. Some of the solutions exploit existing metrics within wireless telecommunication networks such as the received signal strength indicator, RSSI, or channel state information, CSI. Both solutions typically involve machine learning algorithms to infer the number or people from these metrics. Another RF solution, also referred to as impulse radio ultra-wide-band (IR UWB), is based on multi-target detection via radar networks wherein a wide-bandwidth, short-duration pulse is transmitted. The multiple received backscattered signals are then used to detect objects within the radar’s range. The detection itself may then be based on the time-of-arrival or on the time-difference-of-arrival of the different backscattered signals, or on fingerprinting of the signals.

### SUMMARY

The embodiments and features described in this specification that do not fall within the scope of the independent claims, if any, are to be interpreted as examples useful for understanding various embodiments of the invention.

It is an object of the present disclosure to alleviate shortcomings of the prior art and to foresee, amongst others, in a solution for estimating the number of people present in a room that is less sensitive to environmental conditions, that is easily deployable and that is computationally efficient.

This object is achieved, according to a first example aspect of the present disclosure, by a computer-implemented method for estimating a number of persons present in a room comprising: i) obtaining measurements of electromagnetic sounding signals transmitted within the room; ii) determining at least one reverberation time from the measurements; iii) determining the number of people in the room based on the at least one reverberation time, on a room parameter (A0) indicative for a capacity of the room for absorbing the signals and a person parameter (ACS) indicative for an average capacity of a person for absorbing the signals.

The reverberation time is indicative for the time it takes for the signals to decay when the transmission of the sounding signals has stopped. In an enclosed space or room, this decay is dependent on the total absorption capacity of the environment which is largely determined by the absorption capacity of the room together with the absorption capacity of everything within that room. This total absorption capacity for the electromagnetic signals can be determined by measuring the reverberation time of these signals. Furthermore, there is an observable relation between the number of people within the room and the measured reverberation time. Given that the absorption capacity of the room remains the same and a given average absorption capacity of a person, the number of people in the room can be derived from the measured reverberation time by exploiting this relationship.

In other words, the number of people within a room can be determined from a single measurable physical constant that is derivable from time based electromagnetic power measurements. There is thus no need for complex computations such as frequency domain post-processing, channel estimations, channel compensation or machine learning algorithms. Further, there is no dependency on environmental factors such as noise, line of sight, light, gasses or heat making it deployable in industrial environments. By selecting the frequency band of the sounding signals, also disturbance by other RF signals may be avoided. Further, just a single transceiver, i.e. transmitter and receiver, already suffices to obtain the measurements. There is no need for camera’s, lightning or a complex RF communication system. Further, only the room and person parameter need to be known upfront. Both of which can be obtained by a simple calibration procedure or by deriving them beforehand.

According to example embodiments, the number of people is further determined as a ratio between the difference of the total absorption capacity and the room parameter, and the person parameter; wherein the total absorption capacity is derived from the reverberation time.

The reverberation time may further be determined from the measurements by i) determining at least one power delay profile, PDP, expressing an exponential decay in time of power of the electromagnetic sounding signals; and ii) determining the reverberation time as a decay constant indicative for the exponential decay in time.

This way, the number of people in the room is determined by a mere measurement of the received signal power as a function of time.

The decay constant may for example be obtained by fitting an exponential decaying profile with the decay constant onto the so-obtained PDP. Again, this step does not require excessive processing.

When determining the PDP, line of sight, LOS, contributions and/or power values below a certain threshold from the noise may further be discarded. These low complexity operations result in more accurate estimates without the need for improved measurements.

According to example embodiments, the measurements are further spatially averaged, either before or after receiving the measurements. This may for example be achieved by spatial diversity at the transmitter or receiver of the sounding signals, i.e. by more than one transmitter and/or receiver antennas. This results in a considerable improvement of the estimation accuracy, i.e. in a lower estimation error.

Alternatively, or complementary, the electromagnetic sounding signals further comprise orthogonally polarized sounding signals. This also allows spatial averaging of the signals without the need for additional physical antennas.

Further, different measurements of sounding signals in time may be obtained. These measurements may then be averaged over time thereby avoiding small-scale fading effects. More particular, different PDPs may be determined from the different measurement, then these PDPs are averaged over time resulting in an averaged PDP from which the reverberation time is calculated.

According to example embodiments, the room parameter and/or the person parameter are further obtained by performing a calibration. Performing such calibration may for example be done by using a first set of measurements for deriving the room and/or person parameter. This way, no labour-intensive labelling operation is needed as is the case with machine learning algorithms. Due to the nature of relation between the reverberation time and the number of people, the calibration may even be done in an automated way.

The more reverberant the room is, e.g. when the room has a quality factor higher than 5, preferably higher than 100, more preferably higher than 1000, the better or more accurate the estimation becomes when performing the estimations by the same measurement equipment. This makes the method applicably in harsh environments such as on ships which are highly reverberant due to the metal walls.

According to a second example aspect, the disclosure relates to a controller comprising at least one processor and at least one memory including computer program code, the at least one memory and computer program code configured to, with the at least one processor, cause the controller to perform the method according the first example aspect.

According to a third example aspect, the disclosure relates to a system comprising a transmitter configured to transmit electromagnetic sounding signals within a room and a receiver configure to perform measurements of reflections of the electromagnetic sounding signals; and further configured to perform the method according the first example aspect.

According to a fourth example aspect, the disclosure relates to a room configured with the system according to the third example aspect.

According to a fifth example aspect, the disclosure relates to a computer program product comprising computer-executable instructions for causing an apparatus to perform at least the method according to the first example aspect.

According to a sixth example aspect, the disclosure relates to a computer readable storage medium comprising computer-executable instructions for performing the method according to the first example aspect when the program is run on a computer.

### BRIEF DESCRIPTION OF THE DRAWINGS

Some example embodiments will now be described with reference to the accompanying drawings.

FIG. 1 shows an example embodiment of a room equipped with a system for estimating the number of people present in the room;

FIG. 2 illustrates different steps for estimating the number of people in a room from electromagnetic sounding measurements;

FIG. 3 shows a graph illustrating the reverberation time as a function of the number of people present in the room;

FIG. 4 shows a histogram with the error in estimating the number of people in a room as a function of the amount of spatial averaging;

FIG. 5 shows an example embodiment of a suitable computing system for performing one or several steps in embodiments of the invention; and

FIG. 6 shows a histogram with the error in estimating the number of people in a room as a function of the amount of temporal averaging.

### DETAILED DESCRIPTION OF EMBODIMENT(S)

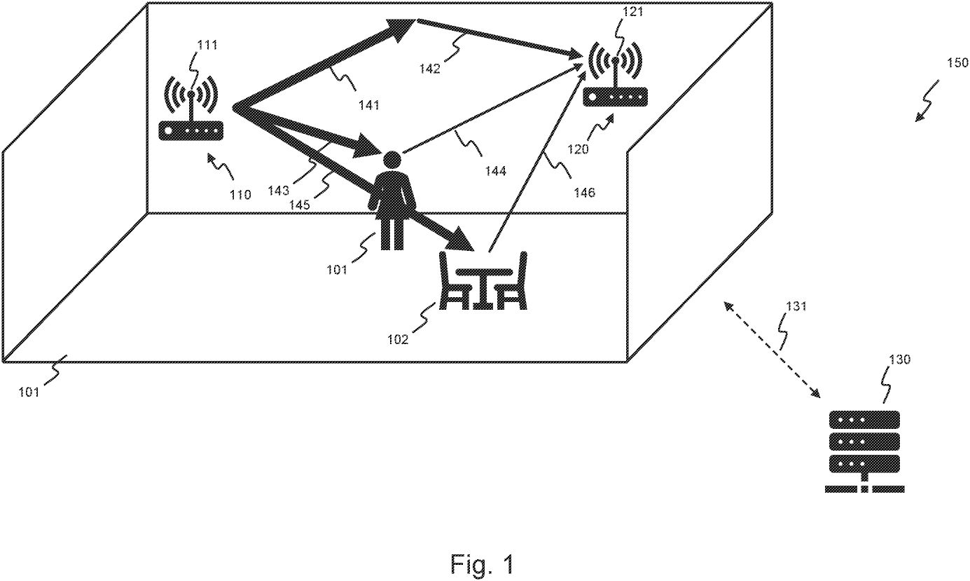

FIG. 1 illustrates a room 100 equipped with a system 150 for estimating the number of people 101 present in the room 100 according to an example embodiment. The system comprises a transmitter 110 and receiver 120 installed within the room. Transmitter 110 and receiver 120 may also be provided as a single device, also referred to as a transceiver. Transmitter 110 is configured to transmit electromagnetic sounding signals 141, 143, 145 by at least one antenna 111. A sounding signal corresponds to a radio frequency, RF, pulse with a certain bandwidth and a certain duration in time. The receiver 120 also comprises at least one antenna 121 for receiving the sounding signals 142, 144, 146. The sounding signals will partly scatter throughout the room by the electromagnetic reflectance properties of the room itself, of objects 102 located within the room 100 and of people 101 located within the room 100. These scattered signals will arrive at different moments in time at the receiver 110. The transmitted signals will also be partly absorbed by the room and by objects located within the room. The sounding signals 142, 144, 146 received by receiver 110 are then provided as measurements 131 to a controller 130 for further estimation of the number of people 101 within room 100 therefrom. The transmitted sounding signals 141, 143, 145 may further comprise different orthogonally polarized sounding signals. For example, the sounding signal may be transmitted with a vertically and horizontally polarized portion. Receiver 120 may further be configured to receive the different orthogonally polarized sounding signal components.

The measurements 131 comprise a representation of the received signal strength or power of the sounding signal as a function of time. To this end, receiver 120 may comprise various circuitries for providing such representation such as an analogue front end for providing an analogue signal representation, a filter for filtering out the sounding signal from the received signal according to the bandwidth of the sounding signal, an analogue to digital converter, and digital baseband circuitry for providing digital time domain or frequency domain processing. Some of these functions may also be performed within the controller 130. Alternatively, controller 130 may also be part of receiver 120. Transmitter 110 may comprise similar circuitry for transmitting the sounding signals.

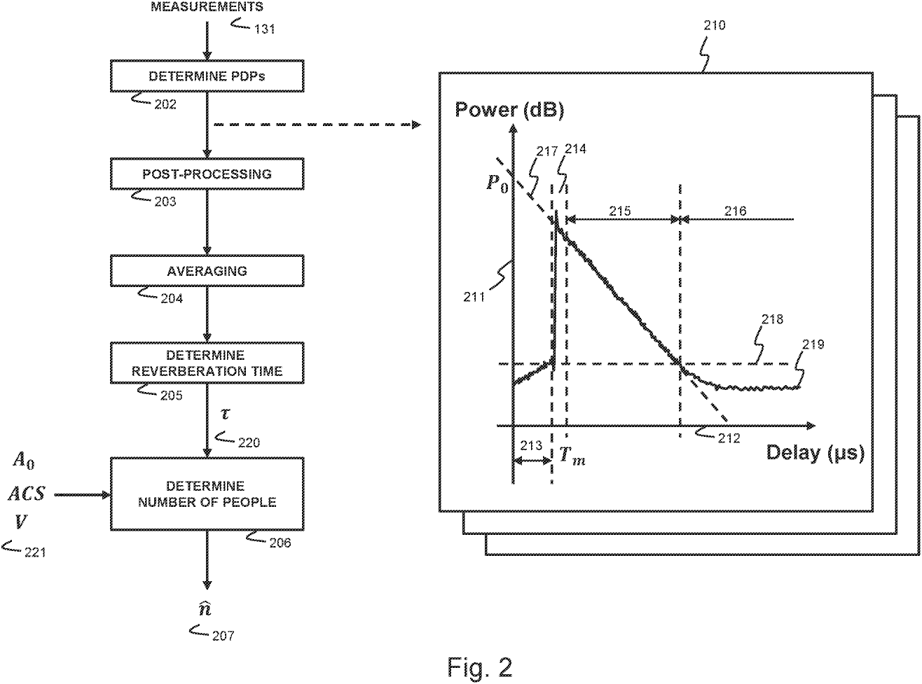

FIG. 2 illustrates steps according to an example embodiment performed by controller 130 for estimating the number of people 101 that are present in room 100 from the obtained measurements 131. In a first step, the measurements 131 are obtained from receiver 120. When controller 130 is located remotely from receiver 120, the measurements 131 may be provided over a wired or wireless communication network.

In a second step, one or more power-delay profiles, PDPs, 210 are determined from the measurements. A power delay profile expresses the decay in power as a function of time of the received sounding signal. An illustrative example 210 of such a PDP is also shown in FIG. 2. On the vertical axis 211 the gain or power is represented in decibel, dB, expressing the difference in power between the transmitted sounding signal 141, 143, 145 and the received sounding signal 142, 144, 146. This gain may be expressed as normalized power of the received signal with respect to the maximum received signal power. On the horizontal axis 212 the delay is expressed in units of time, e.g. in microseconds. The origin then has a delay of zero corresponding with the time at which the sounding signal is transmitted. The PDP illustrates how the transmitted signal power is spread in time due to the scattering of the sounding signals throughout the room. During a first period of time 213, the sounding signal is already transmitted but not yet received at the receiver 120. The observed gain then expresses the noise level of the system 150. Then, during a next period of time 214, the gain sharply raises to a maximum due to the reception of the sounding signal along the shortest path, i.e. along the line of sight, LOS, between the transmitter 110 and receiver 120. Then, during a next period of time 215, the gain shows an exponential decay 217 because the longer the delay, the weaker the scattered sounding signal becomes due to the partial absorption of the signals. As the gain is expressed on a logarithmic scale, the exponential decay is visualized by a linear decay. Then, during a last period 216, the decay stops and the received gain is no longer visible as it drops below the noise floor of the system.

During step 202, multiple PDPs may be obtained. When receiver 120 has multiple receive antennas 121, 122, then a PDP may be obtained from each of the receive antennas thereby exploiting spatial diversity. When the transmitter 110 has multiple transmit antennas, the received signal and thus measurement will be an average of the path from each of the transmit antennas 111, 112 to one of the receive antennas. In other words, transmitter 110 and receiver 120 may be provided as a single-input single-output, SISO, system, as a multiple-input multiple output, MIMO, system, as a single-input multiple-output, SIMO, system, and as a multiple-input single-output, MISO, system. By applying signal processing techniques exploiting this spatial diversity as available in the art, the measurements and thus the derived PDPs may be obtained for each channel. Similarly, when different orthogonally polarized sounding signals are used, different measurements and thus PDPs may be obtained for the so-obtained different combinations. For example, when vertical, V, and horizontal, H, polarization is used at both transmitter 110 and receiver 120, a PDP may be constructed for each of the combinations, i.e. VV, VH, HH and HV. Last, as the sounding signals are very short in time, several sounding signals may be transmitted and received sequentially in time.

As a next step 203, post-processing may be applied to the obtained PDPs 210 to eliminate non-linearities. First, the LOS component visible during period 214 may be removed from the PDPs by discarding all gain values from the origin up to after period 214. For example, all values before the mean arrival time Tₘ of the transmitted sounding signals may be discarded from the PDPs wherein Tₘ can be obtained as

$${T}_{m} = \frac{{\sum }_{t} t . P ( t )}{{\sum }_{t} P ( t )}$$

; and wherein P(t) is the expression for the PDP 210 as a function of time t. Second, contributions by noise may be discarded by discarding all values from the PDP where the PDP drops below a certain threshold value 218. This threshold value may be chosen as a certain amount of dB above the noise floor 219, e.g. 5 dB. To obtain the noise floor itself, power values 219 with large delays in the PDP where no sounding signal contributions above the noise floor are expected may be averaged. As a result of step 203, the constant decay portion 215 of the PDPs is obtained.

When using spatial diversity by polarization or multiple antennas the multiple PDPs are first averaged in step 204 to obtain a single averaged PDP. This way small-scale fading effects may be avoided. Further, different measurements 131 of sounding signals in time may be obtained. These measurements 131 may then be averaged over time thereby again avoiding small-scale fading effects. More particular, different PDPs 210 may be determined from the different measurement, then these PDPs are averaged over time resulting in an averaged PDP from which the reverberation time is calculated.

Then, in a next step 205, the reverberation time τ, RT, is derived from the respective PDPs 210. The RT characterizes the exponential decay of power of the received sounding signals. When expressing the power in dB, the decay will result in a linear slope 217. The exponential decay portion 215 of the PDP 210 may be modelled as P(t) = P₀e‾^{t/τ} (Eq. 1). The RT τ may then be obtained by fitting this model on the measured PDP 210, e.g. by fitting a least-square regression line through the PDP over the delay period 215.

It has been observed that there is a inverse relationship between the reverberation time and the number of persons 101 in a room 100. By exploiting this relationship, the number of persons n̂ 207 is derived in the next step 206. More particular, this relationship may be modelled by the relation that the total absorption area of the room 100 is related to the number of people present in the room by the equation Aₙ = A₀ + n × ACS (Eq. 2) wherein Aₙ is the total absorption area of the electromagnetic sounding signals in the room when n number of persons are present; wherein A₀ is the total absorption area of the electromagnetic sounding signals in the room when no persons are present; and wherein ACS is the average absorption area of a person. Furthermore, the reverberation time of a room is related to the absorption area by the relation

$$τ = \frac{4. V}{c . {A}_{n}}$$

wherein V is the total volume of the room and c is the velocity of light. From these two equations, the estimated number of people n̂ may be expressed as

$$\hat{n} = \left[\frac{\frac{4. V}{c . τ} - {A}_{0}}{A C S}\right]$$

wherein the square brackets represent a rounding operation towards the nearest integer value.

Constant parameters V, A₀, ACS may be obtained during a calibration step. Parameter A₀ may be derived from measurements wherein no person is present in the room as A₀ = ^{4.}^{V}/_{c.}_{τ0} (Eq. 4) with τ₀ the RT as obtained by steps 201-205. Then, the parameter ACS may be obtained as (Aₙ — A₀)/n = ACS for a given number of people n that are present in the room. Alternatively, the parameters may be obtained relative to the total volume, i.e. a first parameter related to the room as A₀/V = ⁴/_{c.} _{τ0} and, similarly, a second parameter related to a person ACS/V. This has the advantage that the volume of the room does not need to be known or estimated.

The above described steps 202-206 and system 150 for estimating the number of people in a room will result in a better estimation the more the room is reverberating. In electromagnetics, the level of reverberation in a cavity, i.e. room, may be expressed by the quality factor Q describing the capacity of reverberation rooms to store electromagnetic energy. The quality factor Q is defined as the ratio of the energy stored to the energy dissipated in the cavity per unit cycle at which the energy is measured. For rooms that support many internal reflections, such as rooms with metal-walls, the fields and energy density follow the characteristics of such reverberation rooms. Good estimation results have been obtained when the room has a large Q factor, preferably larger than five, more preferably larger than 100, even more preferably larger than 1000. Good estimations may be obtained in rooms with metal-walls such as found on ships.

A further detailed embodiment of a system for estimating the number of people in a room using the aforementioned steps 202-207 will now be described. An experimental setup of a transmitter and receiver according to this embodiment was installed in the steering gears room of a bulk carrier vessel. The room has a height of 4 m and a volume V of 600 m³, approximately.

The transmitter and receiver both comprise a dual-polarized patch 8-element antenna array with horizontal, H, and vertical, V, polarization. For this measurement campaign, 8- element rectangular antenna arrays are used at both the transmitter, Tx, and receiver, Rx. Orthogonal frequency division multiplexing, OFDM, is used to encode the eight parallel sounding channels. Each of the channels is further connected to a two-port RF switch for the two polarizations, thereby obtaining 16 by 16 channels for the sounding signals between the transmitter and the receiver, i.e. for the measurements. The centre frequency is 1.35 GHz and the transmission bandwidth is 80 MHz. Further specifications of the transmitter and receiver are provided in Table 1 below.

TABLE 1

Channel sounder specifications

| | |
|---|---|
| Parameter | Setting |
| centre frequency | 1.35 GHz |
| bandwidth | 80 MHz |
| number of Tx and Rx antennas | 8 |
| Tx and Rx polarization | Horizontal and Vertical |
| number of OFDM subcarriers | 6560 |
| OFDM symbol duration Ts | 81.92 µs |
| cyclic prefix duration T_{CP} | 0 ≤ T_{CP} ≤ Ts |

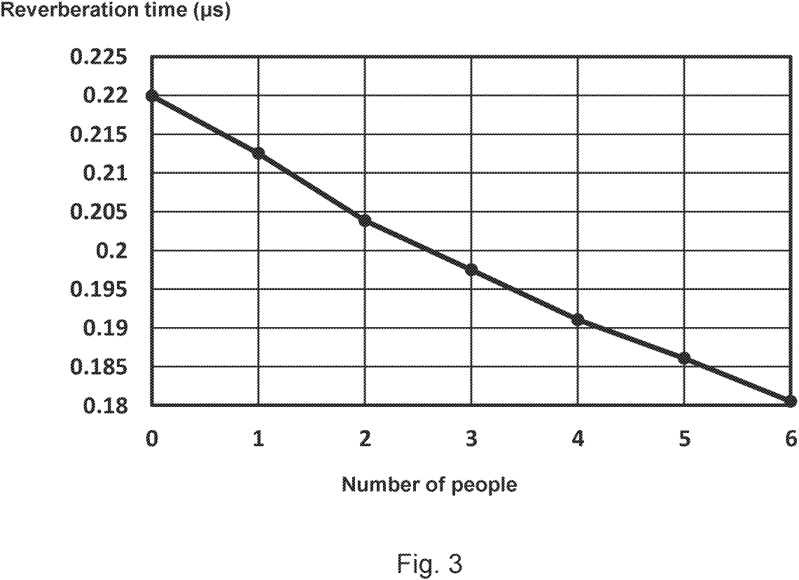

All channels were then measured 200 times and averaged to reduce measurement noise for an amount of people ranging from zero to six. From the measurements, the RT was calculated as a function of the number of people present in the room according to the steps 202-207 as described with reference to FIG. 2. FIG. 3 shows the so-obtained RT as a function of the number of people after spatial and time averaging. From FIG. 3 it may be observed that the RT is inversely proportional to the number of persons in an almost linear way as already established by Eq. 4 above. The same measurements were further performed for different locations of the transmitter and receiver. This showed that there is no notable difference in the RT for different locations, further demonstrating the reverberating nature of the room having metal walls.

Both A₀ and ACS were estimated by a calibration step as described above. For this calibration, 20% of the measurements were used. The remaining 80% was then used for verification of the estimations. Table 2 below summarizes the calculated calibration values from both the full data set and the calibration set. The small difference between the values of the two sets indicates the accuracy of this calibration step.

TABLE 2

Channel sounder specifications

| | Full data set | Calibration set (20%) |
|---|---|---|
| ACS | 1.33 | 1.26 |
| A₀ | 36.44 | 36.57 |

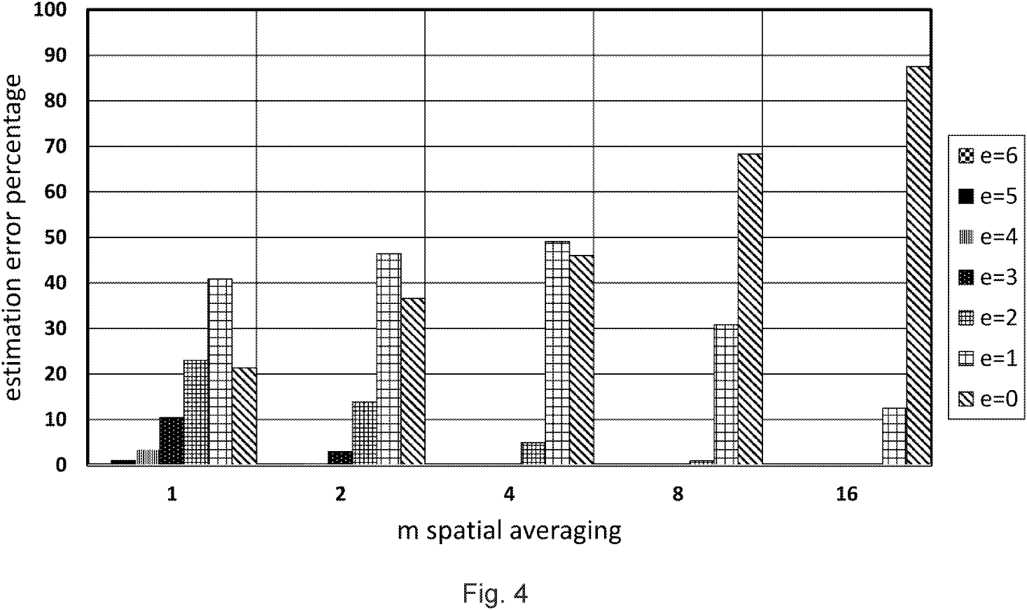

The remaining 80% of the data set was then used to estimate the number of people n̂. From this estimation, an estimation error e is defined as e = |n - n̂|. FIG. 4 shows a histogram of this estimation error for a different number of channels m, i.e. for PDPs that were obtained by averaging the PDPs from different antenna configurations. For a 1x1 (SISO) antenna configuration, i.e. for m = 1, the estimation error can reach up to 6 persons with an estimation success rate of 21.4%. As m increases, the estimation performance improves in terms of higher success rate and smaller number of persons as estimation error. With 16 channels, the success rate is 88% with only a 1-person error of 12%.

Another experimental setup was installed in the same room using off-the-shelf products. The transmitter and receiver both comprise an 8-element array of ultra wideband, UWB, DW1000 nodes with vertically polarized antennas. The centre frequency is 4.99 GHz and the transmission bandwidth is 900 MHz. The channels were then measured 200 times for an amount of people ranging from zero to six. From the measurements, the RT was calculated as a function of the number of people present in the room according to the steps 202-207 as described with reference to FIG. 2. Both A₀ and ACS were estimated by a calibration step as described above.

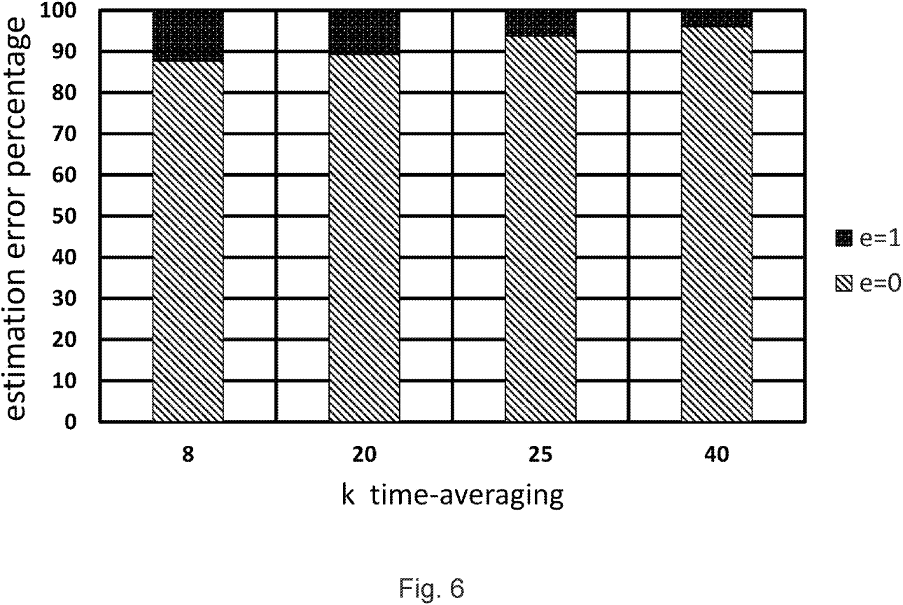

The data set was then used to estimate the number of people n̂ as described above and the estimation error e calculated. FIG. 6 shows a histogram of this estimation error for 32 spatially averaged channels (m = 32) for a different number of time-averaging k, i.e. for PDPs that were obtained by averaging the PDPs from 32 spatial channels and k time instances. As k increases, the estimation performance improves in terms of higher success rate and smaller number of persons as estimation error. With 40 time-averaged channels, the success rate is 96% with only a 1-person error of 4%.

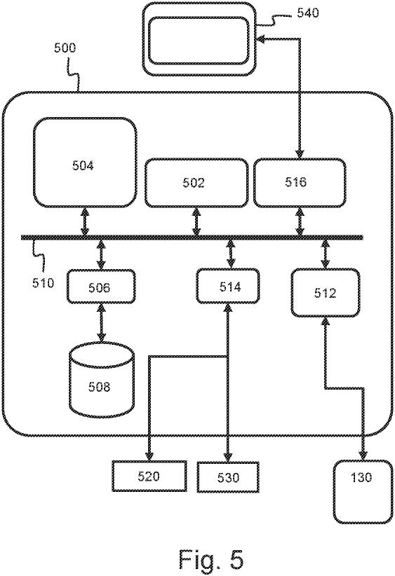

FIG. 5 shows a suitable computing system 500 enabling to implement embodiments of the method for estimating the number of persons present in a room. Computing system 500 may in general be formed as a suitable general-purpose computer and comprise a bus 510, a processor 502, a local memory 504, one or more optional input interfaces 514, one or more optional output interfaces 516, a communication interface 512, a storage element interface 506, and one or more storage elements 508. Bus 510 may comprise one or more conductors that permit communication among the components of the computing system 500. Processor 502 may include any type of conventional processor or microprocessor that interprets and executes programming instructions. Local memory 504 may include a random-access memory (RAM) or another type of dynamic storage device that stores information and instructions for execution by processor 502 and/or a read only memory (ROM) or another type of static storage device that stores static information and instructions for use by processor 502. Input interface 514 may comprise one or more conventional mechanisms that permit an operator or user to input information to the computing device 500, such as a keyboard 520, a mouse 530, a pen, voice recognition and/or biometric mechanisms, a camera, etc. Output interface 516 may comprise one or more conventional mechanisms that output information to the operator or user, such as a display 540, etc. Communication interface 512 may comprise any transceiver-like mechanism such as for example one or more Ethernet interfaces that enables computing system 500 to communicate with other devices and/or systems, for example with transmitter 110 and receiver 120. The communication interface 512 of computing system 500 may be connected to such another computing system by means of a local area network (LAN) or a wide area network (WAN) such as for example the internet. Storage element interface 506 may comprise a storage interface such as for example a Serial Advanced Technology Attachment (SATA) interface or a Small Computer System Interface (SCSI) for connecting bus 510 to one or more storage elements 508, such as one or more local disks, for example SATA disk drives, and control the reading and writing of data to and/or from these storage elements 508. Although the storage element(s) 508 above is/are described as a local disk, in general any other suitable computer-readable media such as a removable magnetic disk, optical storage media such as a CD or DVD, -ROM disk, solid state drives, flash memory cards, ... could be used. Computing system 500 could thus correspond to the controller circuitry 130.

As used in this application, the term “circuitry” may refer to one or more or all of the following:
(a) hardware-only circuit implementations such as implementations in only analogue and/or digital circuitry and
(b) combinations of hardware circuits and software, such as (as applicable):
   (i) a combination of analogue and/or digital hardware circuit(s) with software/firmware and
   (ii) any portions of hardware processor(s) with software (including digital signal processor(s)), software, and memory(ies) that work together to cause an apparatus, such as a mobile phone or server, to perform various functions) and
(c) hardware circuit(s) and/or processor(s), such as microprocessor(s) or a portion of a microprocessor(s), that requires software (e.g. firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in a server, a cellular network device, or other computing or network device.

Although the present invention has been illustrated by reference to specific embodiments, it will be apparent to those skilled in the art that the invention is not limited to the details of the foregoing illustrative embodiments, and that the present invention may be embodied with various changes and modifications without departing from the scope thereof. The present embodiments are therefore to be considered in all respects as illustrative and not restrictive, the scope of the invention being indicated by the appended claims rather than by the foregoing description, and all changes which come within the scope of the claims are therefore intended to be embraced therein.

It will furthermore be understood by the reader of this patent application that the words “comprising” or “comprise” do not exclude other elements or steps, that the words “a” or “an” do not exclude a plurality, and that a single element, such as a computer system, a processor, or another integrated unit may fulfil the functions of several means recited in the claims. Any reference signs in the claims shall not be construed as limiting the respective claims concerned. The terms “first”, “second”, third”, “a”, “b”, “c”, and the like, when used in the description or in the claims are introduced to distinguish between similar elements or steps and are not necessarily describing a sequential or chronological order. Similarly, the terms “top”, “bottom”, “over”, “under”, and the like are introduced for descriptive purposes and not necessarily to denote relative positions. It is to be understood that the terms so used are interchangeable under appropriate circumstances and embodiments of the invention are capable of operating according to the present invention in other sequences, or in orientations different from the one(s) described or illustrated above.

1-15. (canceled)

16. A computer-implemented method for estimating a number of persons present in a room comprising:
obtaining measurements of electromagnetic sounding signals transmitted within the room;
determining at least one reverberation time from the measurements;
determining the number of people in the room based on the at least one reverberation time, on a room parameter indicative for a capacity of the room for absorbing the signals and a person parameter indicative for an average capacity of a person for absorbing the signals.

17. The method according to claim 16, wherein the determining the number of people further comprises determining from the reverberation time a total absorption capacity of the room with the number of persons present.

18. The method according to claim 17, wherein the number of people is further determined by a ratio between the difference of the total absorption capacity and the room parameter, and the person parameter.

19. The method according to claim 16, wherein the determining at least one reverberation time further comprises:
determining at least one power delay profile, PDP, expressing an exponential decay in time of power of the electromagnetic sounding signals;
determining the reverberation time as a decay constant indicative for the exponential decay in time.

20. The method according to claim 19, wherein the determining the PDP comprises:
discarding line of sight, LOS, contributions in the PDP.

21. The method according to claim 19, wherein the determining the PDP comprises:
discarding power below a certain threshold from a noise floor.

22. The method according to claim 19, wherein the determining the PDP comprises:
fitting an exponential decaying profile with the decay constant onto the obtained PDP.

23. The method according to claim 16, wherein the electromagnetic sounding signals are transmitted by an antenna array.

24. The method according to claim 16, wherein the measurements are obtained by an antenna array.

25. The method according to claim 16, wherein the electromagnetic sounding signals comprise orthogonally polarized sounding signals.

26. The method according to claim 16, further comprising performing a calibration for determining the room parameter and/or the person parameter.

27. The method according to claim 16, wherein the room has a quality factor higher than 5, preferably higher than 100, more preferably higher than 1000.

28. A controller comprising at least one processor and at least one memory including computer program code, the at least one memory and computer program code configured to, with the at least one processor, cause the controller to perform the method according to claim 16.

29. A system comprising a transmitter configured to transmit electromagnetic sounding signals within a room and a receiver configure to perform measurements of reflections of the electromagnetic sounding signals; and further configured to perform the method according to claim 16.

30. A room configured with the system according to claim 29 for measuring the number of people in the room.
